(19) United States
(12) Patent Application Publication
(10) Pub. No.: US 2010/0080940 A1
(43) Pub. Date: Apr. 1, 2010

(54) OPAQUE THERMOPLASTIC MULTILAYER SHEET, AND METHOD FOR MANUFACTURE THEREOF

(75) Inventor: Thomas Godey, Gouvieux (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: PRIPLAK, Neuilly-En-Thelle (FR)

(21) Appl. No.: 12/527,365

(22) PCT Filed: Feb. 15, 2008
(86) PCT No.: PCT/FR2008/000203

§ 371 Date: Oct. 27, 2009

(30) Foreign Application Priority Data
Feb. 16, 2007 (FR) 0701160

(51) Int. Cl. B41M 5/00; B32B 27/32; B29C 47/06

(52) U.S. Cl. 428/32.18; 428/220; 428/195.1; 264/173.16

(57) ABSTRACT

The invention concerns a thermoplastic multilayer sheet (1) which is opaque in transmission, having a density of 1 g/cm³ or less and a thickness of 500 μm or less, each of its faces having a uniform surface finish, said sheet comprising at least three extruded layers including an opaque internal layer (2) and at least two external layers (3, 4) of thermoplastic ma which is not completely opaque, said internal layer (2) comprising a thermoplastic material and an opacifying charge. The invention also concerns a method for manufacturing said opaque thermoplastic sheet (1) comprising a step for co-extrusion and a step for “press-cool-finishing” said co-extruded polymer (5) between a cooling roll (7) and an endless belt (8) providing said sheet (1) with the required thickness and a uniform surface finish. It also concerns its application to various sheets, in particular hanging banners or playing cards or scratch cards.

The present invention relates to a sheet of thermoplastic material which is opaque to transmitted light, having a uniform surface finish and more particularly with a thickness of 500 μm or less. The invention also relates to a method for manufacturing said opaque thermoplastic sheet with a thickness of 500 μm or less.

Sheets of synthetic material are already known which preferably can be printed using any printing method, for example screen printing, flexography, offset printing or using digital techniques such as INDIGO® laser printing from HP or by inkjet printing. Such sheets may be rigid or flexible to a greater or lesser extent depending on how thickness they are and on their composition. Such sheets produced from plastic material are very often coloured (including white) in their bulk. In order to carry out such coloration, pigments or colorants are used which provide the sheet with an opacity which may be more or less pronounced depending on chemical composition of the pigment or the colorant and depending on the desired final shade. However, sheets which are thus coloured are intended to be printed not only recto but also verso. However, in general, such coloured sheets lack opacity, which means that when one face is printed, that printing can be seen from the opposite face due to transparency.

Such sheets are intended to be used, for example, as a hanging banner or POS advertisement (point of sale advertisement), as a label in particular of the “shelf talker” type which is positioned approximately perpendicular to range out of which it projects, or as a personalized card or playing card or scratch card.

The lack of opacity of the sheets means that when a plastic sheet is printed recto and verso to make a banner which is intended to be hung up, the printing on the back of the banner may be seen by transparency. By the same principle, a banner applied to the bottom of a store window can let light from inside the store pass through to the street or, conversely, passers by, for example, may be seen outside when looking from the inside of the store. For security reasons, labels or printed cards (playing cards, scratch cards, membership cards, etc) must have a high level of opacity.

Thus, in order to try to compensate for the lack of opacity of sheets formed from plastic material, the concentration of pigments or colorants in the plastic material composition was increased. However, increasing the concentration of pigment has a number of disadvantages. A first disadvantage is an increase in the density and the cost price of such sheets because of the high proportion of colorant materials. Further, increasing the concentration of colorant materials (pigments or colorants) cannot in the majority of cases produce sufficient opacity, i.e. non-transmission of light through the sheet. A third disadvantage is that increasing the proportion of colorant materials in the composition might modify the mechanical characteristics of the sheet and, more particularly, might substantially reduce the tensile strength of the sheet. A fourth disadvantage may be a reduction in the printability characteristics of the sheet due to the large quantity of colorant materials which might migrate or modify the surface characteristics.

Patent application EP-A-0 441 694 describes opaque thermoplastic sheets made by co-extrusion of a central opaque layer and external non-opaque layers. In practice, these sheets are relatively thick, of the order of 1 mm (1000 μm) depending on the examples. In fact, if the thickness of the co-extruded polymer obtained at the outlet from the extrusion die is to be reduced to obtain thinner sheets, i.e. sheets less than 500 μm thick, until now various means have been employed. One of these means is calendaring between two rolls; this also allows the sheet to be provided with a surface finish (matt, gloss, texture), but a problem has been observed, due to the fact that the internal layer is a dark colour, namely that the surface finish of the finished sheet is not uniform; in fact that method causes the layers to shear when sheets less than 500 μm thick are required, thus causing the layers to blend somewhat, and causing the opaque layer to marble somewhat into the other layers; a non-uniformity of the gloss or matt finish is also observed, in particular if identical effects are required recto and verso. Thus, that method is not suitable for producing relatively thin sheets.

The other means are “cast” extrusion and blowing, which can produce a fairly thin sheet but they cannot be used to provide the sheet with a matt, gloss and/or textured (or grained) surface finish.

The aim of the present invention is to provide a thermoplastic sheet, in particular formed from polypropylene, which is opaque as regards transmission and relatively thin, in particular 500 μm or less, which does not have the disadvantages mentioned above.

Thus, a first aim of the invention is to provide a sheet of thermoplastic material which is completely opaque, i.e. which does not transmit visible light, and which is not too thick, i.e. 500 μm or less, and which has a uniform surface finish over each of its faces, i.e. without undesirable variation in colour and, if appropriate, gloss (mattness) and/or texture (grain) with respect to the desired surface quality.

A second aim of the invention is to provide a sheet of thermoplastic material which, while being opaque, has a fairly low density, at the same level as that of a non-opaque monolayer or multilayer sheet and without substantially increasing the cost price.

A third aim of the invention is to provide a sheet of thermoplastic material which, while being opaque, has very good printing qualities when using the usual printing means.

Another aim of the invention is to provide a sheet of thermoplastic material which, while being opaque, has good tensile strength, which is not degraded with respect to a non-opaque sheet.

To this end, the invention provides a thermoplastic multilayer sheet 1 which is opaque in transmission, having a density of less than 1 g/cm³ and a thickness of 500 μm or less, each of its faces having a uniform surface finish, said sheet comprising at least three extruded layers including an opaque internal layer 2 and at least two external layers 3, 4 formed from thermoplastic material which are not completely opaque (in transmission), the internal layer 2 comprising a thermoplastic material and an opacifying charge.

In the present description, the term “opaque” or “opaque in transmission” means that the quantity of light transmitted through the sheet is almost zero. The term “not completely opaque” means that a certain quantity of light can be transmitted and it is possible to see through it.

An opaque sheet 1 of the invention is such that the quantity of light transmitted through said sheet from a luminous source of 14000 Lux is 10 Lux or less, preferably 5 Lux or less.

Further, the term “sheet” as used in the present description means a sheet which may be a sheet of a given format or a continuous sheet.

The “uniform surface finish” relates to the surface colour of each of the faces of the sheet, and also concerns the gloss (mattness) and/or texture.

In accordance with a preferred embodiment of the invention, the opacifying charge comprises a pigmentary colorant which is dark in colour. Preferably, said pigmentary colorant is carbon black.

The opaque layer 2 may also include pigmentary colorants with a colour which is close (as close as possible) to that of one or both external layers and/or titanium dioxide. As an example, and more particularly in the case of a white sheet, titanium dioxide may be added which contributes to balancing the colour of the sheet and which also contributes to opacity.

Preferably, the opacifying charge is a mixture of carbon black and titanium dioxide.

As an example, it may be possible to bulk colour the external layers as a function of the selected shade (or two different shades if desired) by adding a pre-mix of thermoplastic material and a pigmentary colorant or a (soluble) colorant to the basic thermoplastic material.

The proportions of the opacifying charge in the internal layer 2 depend on the total thickness of the sheet 1 and its desired final external shade; this shade will be influenced by the non-opacity of the external layers and the opacity and colour of the internal layer.

More particularly, the internal layer 2 contains in the range 1% to 10%, preferably in the range 2% to 5% of opacifying charge, as a dry weight with respect to the weight of thermoplastic material in said layer 2.

Preferably, in accordance with the invention, the thermoplastic material is selected from polyolefins, in particular polypropylene, polyethylene, polyesters in particular polyethylene terephthalate (PET), polystyrene and mixtures thereof.

The invention preferably concerns sheets based on polypropylene.

More particularly, the thickness of the internal layer 2 may be 5% to 25% of the total thickness of the finished sheet, more particularly in the range 10% to 20%.

The total thickness of the sheet of the invention is in the range 100 to 500 μm, in particular in the range 150 to 350 μm.

In accordance with a particular embodiment of the invention, the thickness of the internal layer 2 is in the range 15 to 35 μm, and the thickness of each external layer 3, 4 is in the range 85 to 100 μm.

In accordance with another particular embodiment of the invention, the thickness of the internal layer 2 is in the range 50 to 80 μm and the thickness of each external layer 3, 4 is in the range 150 to 210 μm.

In accordance with the invention, each face of the sheet, and thus the external faces of the external layers 3, 4, has a surface finish which may be matt, gloss, or have a particular texture (or grain) or a combination of these finishes. These finishes are uniform over the whole surface of the face of the sheet or are in a motif which may, for example, have both gloss and mattness. In a particular case of the invention, each face has an identical surface finish; in particular, said faces have an identical degree of gloss.

In a particular case of the invention, the sheet 1 is a triple layer co-extruded sheet constituted by said opaque internal layer 2 and said two external layers 3, 4 which are not completely opaque.

The opacity of the sheet of the invention is not due to the presence of micro-holes.

Said sheet 1 can be printed by screen printing, flexography, offset printing or using digital techniques such as INDIGO® laser printing from HP or by inkjet printing.

As mentioned above, the prior art reveals that the manufacture of a thermoplastic multilayer sheet which is opaque in transmission with a density of 1 g/cm³ or less and a thickness of 500 μm or less and wherein each of the faces has a uniform surface finish, presents many difficulties.

The invention aims to overcome the prior art problems with opaque thermoplastic sheets by proposing a manufacturing method which endows said thermoplastic sheets which are opaque in transmission with both a relatively low thickness, i.e. 500 μm or less, a uniform surface finish over each of their faces, i.e. without unwanted variation in colour and if appropriate gloss (mattness) and/or texture (grain), and good printability.

The invention thus also concerns a method for manufacturing such an opaque thermoplastic sheet 1 with a thickness of 500 μm or less.

The method for manufacturing the sheet 1 of the invention comprises a step for co-extrusion of a thermoplastic material to form a co-extruded polymer 5 having a thickness which is greater than that of the sheet 1 and configured such that the layers of the sheet including an opaque internal layer 2 and external layers 3, 4, and a “press-cool-finish” step between a cooling roll 7 and an endless belt 8 endowing the manufactured sheet with both the required thickness and the desired uniform surface finish, for example matt, gloss and/or with a particular texture (or grain). In practice, these steps are carried out in a continuous process.

The method of the invention for manufacturing an opaque thermoplastic sheet 1 with a thickness of 500 μm or less as described above is characterized in that it comprises:
a) a step for co-extrusion to form a co-extruded polymer 5 with a thickness which is greater than that of the sheet 1, by co-extrusion in a flat die 6 of thermoplastic compositions including an opacifying internal composition comprising a thermoplastic material and an opacifying charge which is to form the internal layer 2 and two external compositions based on thermoplastic material which will respectively form the external layers 3, 4; and
b) a “press-cool-finish” step for said co-extruded polymer 5 carried out between a cooling roll 7 and an endless belt 8 providing said sheet 1 with the required thickness and uniform surface finish.

In a particular case of the method of the invention, the step for co-extrusion of the thermoplastic material to form a co-extruded polymer 5 having a thickness which is greater than that of the sheet 1 which is constituted by three layers, namely an opaque internal layer 2 comprising a thermoplastic material and an opacifying charge and two external layers 3, 4 formed from thermoplastic material which is not completely opaque. In accordance with the invention, the opacifying charge of the internal layer 2 comprises a pigmentary colorant which is dark in colour; in particular, said pigmentary colorant is carbon black.

In accordance with the invention, the co-extrusion method is carried out using a flat co-extrusion device which consists of causing a number of streams of thermoplastic material with different compositions, including a “central” composition formed from thermoplastic material and opacifying charges, to penetrate upstream of a flat extrusion die 6 to form a co-extruded polymer 5 with a thickness which is greater, for example approximately double, that of the finished sheet 1, and which exits at a temperature which is higher than the fusion temperature of the material, for example at 230° C. in the case of a polypropylene based material, this co-extruded polymer 5 falling as a curtain onto the surface of the belt 8.

This device can simultaneously stretch/press and cool the extruded means which leaves the die, and thus reduce its thickness, to produce a sheet in accordance with the invention. Further, it endows the sheet with a particular surface finish.

The cooling roll 7 and the endless belt 8 are formed from steel and have a surface finish which will provide the sheet with a surface finish. They may have identical surface qualities, for example matt, gloss and/or the same grain, or they may have different surface qualities in order to provide the sheet with a di-symmetrical surface finish. As an example, the sheet may have a matt face and a glossy face and/or have identical or different grains.

This device does not alter the surface of the sheet, and does not mix the internal layer and the external layers during passage between the belt 8 and the roll 7.

The contact length of the sheet during formation between the cooling roll 7 and the endless belt 8 may be in the range 0.5 to 1 metre. The width of the belt 8 may be in the range 0.5 to 2 metres.

Such a device may be a device known as a “sleeve touch” device sold by the Austrian company SML Maschinengesellschaft mbH, this device being used to produce highly transparent plastic sheets or films.

Further, in order for the sheet to be properly printable, in known manner, it may undergo an electrical discharge treatment which is generally known as a Corona treatment, or a composition of binders and layering pigments may be deposited on the external layers of said film to provide the printability characteristic.

Said sheet can be printed by screen printing, flexography, offset printing or using digital techniques such as INDIGO® laser printing from HP or by inkjet printing.

The invention also concerns the use of an opaque multilayer thermoplastic sheet 1 as described or as manufactured using the above method to produce hanging banners, displays, packaging, pouches, decorative sheets, labels, in particular “shelf talker” labels, personalized cards, playing cards or scratch cards or labels.

The invention also concerns a printed and/or decorated opaque article comprising an opaque thermoplastic sheet 1 as described or manufactured using the above method.

More particularly, the opaque article is a hanging banner, a display, packaging, a pouch, a decorative sheet, a label, in particular a “shelf talker” label, a personalized card, a playing card or a scratch card or label.

The following description of non-limiting examples is made with reference to the accompanying drawings in order to better understand the invention.

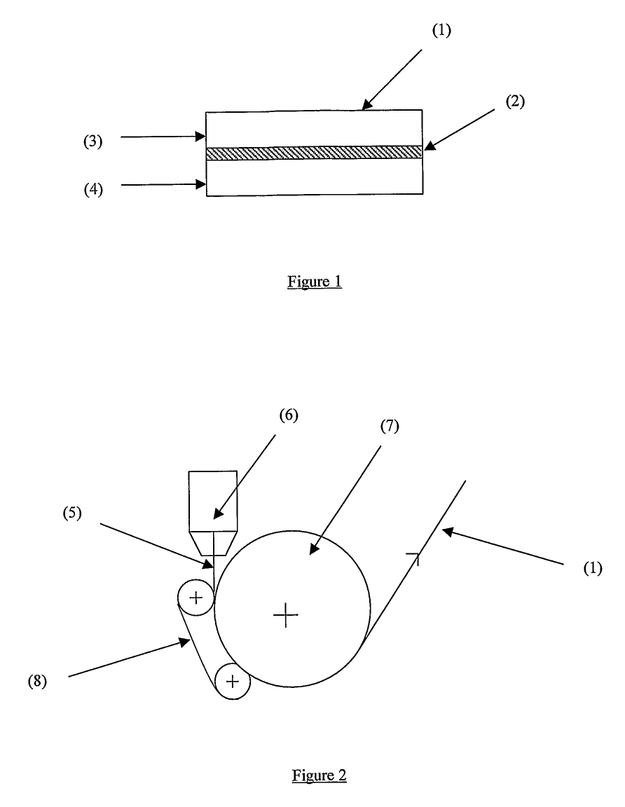

FIG. 1 is a sectional view of an opaque sheet 1 of the invention.

FIG. 2 is a diagram of the method and the manufacturing device used to manufacture said sheet 1.

The proportions between the various elements shown in the figures are not to scale for reasons of clarity.

### EXAMPLE 1

### In Accordance with the Invention

An opaque sheet 1 was formed from polypropylene with a total thickness of 220 μm which was constituted by a 30 μm thick opaque internal layer 2 and two external layers 3, 4 which were not completely opaque, each having a thickness of 95 μm.

The sheet 1 corresponded to that of FIG. 1 and the manufacturing method corresponded to the diagram of FIG. 2.

In a first step, a co-extruded polymer 5 was produced from a flat co-extrusion die 6 by co-extrusion of a central polypropylene composition comprising 4% carbon black and 1% titanium dioxide, by dry weight with respect to the total weight of polypropylene in said layer 2 and two external compositions each produced from polypropylene comprising 10% of TiO₂ by dry weight with respect to the weight of said polypropylene. At the die outlet, the co-extruded polymer 5 was at a temperature of 230° C. and it was 400 μm thick. It fell as a curtain onto the endless belt 8.

Said co-extruded polymer 5 was then stretched/pressed under very low pressure and cooled between a cooling roll 7 which was at a temperature of approximately 70° C. and a steel endless belt 8 (which was cooled), the roll and the belt having a matt chromed surface. The sheet, still in the course of production, was in contact with the roll and the belt over a length of 0.5 m. The roll and the belt had a matt surface quality, a finish which will be transferred by contact to the external layers of the extruded polymer which is being transformed to produce the desired sheet 1.

The sheet obtained had a total thickness of 220 μm, it had a uniform white colour and it was completely opaque, i.e. it did not allow light to pass by transmission.

The degree of opacity of this sheet was determined by measuring the quantity of light transmitted through the sheet from a source of white light of 14000 Lux. A quantity of 1.6 Lux of light was passed through the sheet. To make this measurement, the light source was positioned in front of a detector and its distance was adjusted so that the detector measured 14000 Lux. Next, the sheet was interposed between the light source and the detector, the sheet being placed just in front of the detector, and then the quantity of light transmitted through the sheet 1 which was recorded by the detector was recorded.

For comparison, a sheet of white polypropylene made using the composition of the external layers (with 10% TiO₂) and which was 220 μm thick had 1500 Lux of light passed through it.

To make these measurements, the detector used was a MAVOLUX digital Lux meter, the light source was an incandescent type E2775W light bulb, 24 volts. The test samples were 20 cm×25 cm in size.

A matt (low gloss) sheet was obtained.

The sheet underwent an electrical discharge treatment (corona treatment). It could be printed using various printing means such as screen printing, flexography, offset printing or using digital techniques such as INDIGO® laser printing from HP or by inkjet printing.

Gloss measurements were carried out and the uniformity of each of the faces of the sheet was measured as follows:

A measurement was made at 10 points on one of the faces of the sheet 1, the sample measuring 1100 mm×1500 mm, using a Micro-tri-gloss gloss meter using the following angles: 20°, 60°, and 85°. The mean of the ten points was calculated and the standard deviation was determined.

The results are shown in Table 1 below:

TABLE 1

| | 20° angle | 60° angle | 85° angle |
|---|---|---|---|
| Mean gloss | 1.2 | 4.4 | 8.6 |
| Standard deviation | 0.0 | 0.0 | 0.1 |

Whiteness measurements were carried out to verify its uniformity over one of the faces of the sheet as follows:

A measurement was made at 10 points on the sheet 1 of a sample measuring 1100 mm×1500 mm using a color-guide-sphere spectrocolorimeter, using the CIE L,a,b 94 model. The mean of the ten points was calculated and the standard deviation was determined.

The results are shown in Table 2 below:

TABLE 2

| | ΔL | Δa | Δb | ΔE |
|---|---|---|---|---|
| Mean whiteness | 0.05 | 0.02 | 0.03 | 0.09 |
| Standard | 0.09 | 0.02 | 0.04 | 0.07 |
| deviation | | | | |

The whiteness uniformity was also measured on the opposite face; the same results were obtained.

### EXAMPLE 2

### In Accordance with the Invention

An opaque sheet 1 was produced in a manner similar to that of Example 1, but this sheet was thicker, its total thickness was 440 μm, the internal layer 2 was 60 μm thick and the white external layers 3, 4 were 190 μm thick.

The sheet obtained had a uniform surface finish.

The quantity of light transmitted by this sheet 1 for a 14000 Lux source was zero (equal to 0).

1. A thermoplastic multilayer sheet which is opaque in transmission, having a density of less than 1 g/cm³ and a thickness of 500 μm or less, each of its faces having a uniform surface finish, said sheet comprising at least three extruded layers including an opaque internal layer and at least two external layers formed from thermoplastic material which are not completely opaque, said internal layer comprising a thermoplastic material and an opacifying charge.

2. A sheet according to claim 1, wherein said opacifying charge comprises a pigmentary colorant which is dark in colour.

3. A sheet according to claim 2, wherein said pigmentary colorant is carbon black.

4. A sheet according to claim 1, wherein said opaque layer further comprises pigmentary colorants with a colour close to the colour of an external layer.

5. A sheet according to claim 1, wherein in that said opacifying charge is a mixture of carbon black and titanium dioxide.

6. A sheet according to claim 5, wherein the internal layer comprises in the range 1% to 10% of opacifying charge by dry weight with respect to the weight of thermoplastic material in said layer.

7. A sheet according to claim 1, wherein the thermoplastic material is selected from polyolefins.

8. A sheet according to claim 1, wherein the quantity of light transmitted through said sheet from a light source of 14000 Lux is 10 Lux or less.

9. A sheet according to claim 1, wherein the total thickness of said sheet is in the range 100 μm to 500 μm.

10. A sheet according to claim 1, wherein the thickness of the internal layer is 5% to 25% of the total thickness of the sheet.

11. A sheet according to claim 1, wherein each face of said sheet has a surface finish which is matt or gloss, with or without a particular texture.

12. A sheet according to claim 1, wherein the faces of said sheet have an identical level of gloss.

13. A sheet according to claim 1, wherein said sheet is a triple layer co-extruded sheet constituted by said internal opaque layer and said external two layers which are not completely opaque.

14. A sheet according to claim 1, wherein said sheet can be printed by screen printing, flexography, offset printing or using digital techniques such as INDIGO® laser printing from HP or by inkjet printing.

15. A method for manufacturing an opaque thermoplastic sheet having a thickness of 500 μm or less as described in claim 1, comprising:
a) a step for co-extrusion to form a co-extruded polymer with a thickness which is greater than that of the sheet, by co-extrusion in a flat die of thermoplastic compositions including an opacifying internal composition comprising a thermoplastic material and an opacifying charge which is to form the internal layer and two external compositions based on thermoplastic material which will respectively form the external layers; and
b) a “press-cool-finish” step for said co-extruded polymer carried out between a cooling roll and an endless belt providing said sheet with the required thickness and uniform surface finish.

16. A manufacturing method according to claim 15, wherein the thickness of the extruded polymer at the outlet from the co-extrusion die is approximately double that of the total thickness of the sheet.

17. A manufacturing method according to claim 15, wherein the contact length of the extruded polymer upon transformation with said cooling roll and said endless belt is in the range 0.5 to 1 metre.

18. A manufacturing method according to claim 15, wherein it comprises, after step b), a step for treatment providing said sheet (1) with printability qualities, in particular by using electric discharges.

19. Use of a thermoplastic multilayer sheet which is opaque in transmission, having a density of less than 1 g/cm³ and a thickness of 500 μm or less, each of its faces having a uniform surface finish, said sheet comprising at least three extruded layers including an opaque internal layer and at least two external layers formed from thermoplastic material which are not completely opaque, said internal layer comprising a thermoplastic material and an opacifying charge or obtained using the method described in claim 15 for the manufacture of hanging banners, displays, packaging, pouches, decorative sheets, labels, personalized cards, playing cards or scratch cards or labels.

20. An opaque printed and/or decorated article comprising a thermoplastic multilayer sheet which is opaque in transmission, having a density of less than 1 g/cm³ and a thickness of 500 μm or less, each of its faces having a uniform surface finish, said sheet comprising at least three extruded layers including an opaque internal layer and at least two external layers formed from thermoplastic material which are not completely opaque, said internal layer comprising a thermoplastic material and an opacifying charge or obtained using the method described in claims 15.

21. An opaque article according to claim 20, wherein that it is a hanging banner, a display, packaging, a pouch, a decorative sheet, a label, a personalized card, a playing card or a scratch card or label.
